(19) United States
(12) Patent Application Publication
(10) Pub. No.: US 2019/0289879 A1
(43) Pub. Date: Sep. 26, 2019

(54) Method for Reducing Zearalenone Content in Straw Using Steam Explosion Technology and Use Thereof

(71) Applicant: Institute of Animal Sciences, Chinese Academy of of Agricultural Sciences, Beijing (JP)

(72) Inventors: Jiaqi Wang, Beijing (CN); Shengguo Zhao, Beijing (CN); Nan Zheng, Beijing (CN); Yangdong Zhang, Beijing (CN)

(21) Appl. No.: 16/360,113

(22) Filed: Mar. 21, 2019

(30) Foreign Application Priority Data
Mar. 23, 2018 (CN) 201810247485.2

(51) Int. Cl. A23K 10/30; A23K 40/00

(52) U.S. Cl. CPC A23K 10/30; A23N 17/004; A23K 40/00

(57) ABSTRACT

The present disclosure provides a method for reducing zearalenone content in straw using steam explosion technology and use thereof, creatively utilizes the huge energy released during steam explosion, and destroys the chemical structure of zearalenone without introducing other harmful chemicals, wherein the steam explosion technology can be used as a completely new technology for reducing zearalenone content in straw.

### CROSS REFERENCE TO RELATED APPLICATION

This application claims the benefit of and takes priority from Chinese Patent Application Ser. No. 201810247485.2 filed on Mar. 23, 2018, the contents of which are herein incorporated by reference.

### TECHNICAL FIELD

The present disclosure belongs to the technical field of livestock feed processing, and specifically relates to a method for reducing zearalenone content in straw using steam explosion technology and use thereof.

### BACKGROUND

The limit test of fungal toxin residues is a key test and monitoring item for agricultural product safety in China, and is also one of the necessary test items for many agricultural and sideline products to enter the international market. The fungal toxins are toxic secondary metabolites secreted by fungi. The fungal toxins contaminate food and feed, thereby resulting in food spoilage, and poisoning humans and animals. As the countries around the world increasingly pay attention to the management of fungal toxin residues in food and feed, it appears particularly important to reduce the food and feed contamination caused by the fungal toxins, in order to reduce the damage of the fungal toxins to humans and animals.

Zearalenone is also known as F-2 toxin, has a chemical name of 6-(10-hydroxy-6-oxo-trans-1-undecene)-β-resorcyclic acid-lactone, is one of the most widely distributed fusarium mycotoxins, and is mainly derived from strains of Fusarium, such as Fusariumtricinctum and Fusarium graminearum. Zearalenone mainly contaminates cereals, such as maize, wheat, rice, barley, millet, and oats, and has estrogen-like effects, such as reproductive developmental toxicity, immunotoxicity and genotoxicity, and accelerates the formation of tumors. Intake of excessive zearalenone by animals will cause acute poisoning, or even death, thereby resulting in huge economic losses to livestock farms.

Zearalenone is commonly found in moldy straw, especially in maize straw. However, at present, there are no particularly effective methods for reducing the zearalenone content in straw. The traditional physical and chemical methods have the defects, such as poor effects, and tend to introduce other harmful chemicals.

### SUMMARY

In order to solve the above problems existing in the prior art, the present disclosure provides a method for reducing zearalenone content in straw using steam explosion technology and use thereof.

The present disclosure discloses use of the steam explosion technology for reducing zearalenone content in straw.

The steam explosion technology has a long history since it was proposed and used. Its main working principle is to swell up starting materials by steam in an environment at high temperature and under high pressure, fill pores with steam, rapidly gasify overheated liquid in pores of the starting materials when the high pressure is instantaneously removed (millisecond level, within 0.00875 second), enable the cells to “explode” due to rapid volume expansion, form porous cell walls after the cell wall rupture, and release micromolecular substances from within the cells. The steam explosion technology can cause occurrence of a variety of chemical and physical changes of materials only using high temperature steam in processing works without adding any chemical substance, and is therefore considered as the processing approach with best development prospects.

Before the present disclosure, the steam explosion technology improves the crystallinity of cellulose in starting materials, reduces the polymerization degree, softens the lignin, and reduces the horizontal bonding strength. The inventors of the disclosure has found through research on the principle of the steam explosion that the chemical structure of zearalenone can be destroyed using the huge energy released during steam explosion without introducing other harmful chemicals, and the steam explosion technology can be used as a completely new technology for reducing zearalenone content in straw.

The technical solution used by the present disclosure is a method for reducing zearalenone content in straw using steam explosion technology, wherein straw is processed using a steam explosion method with 1-2.2 MPa of steam pressure of steam explosion, 30-200 s of pressure maintaining time, and 10-50% water content of straw.

The inventors of the present disclosure further select parameters of the steam explosion technology to give straw containing zearalenone at a lower concentration after processing. Tests show that it is possible to better meet the requirements for reducing zearalenone content using the above parameters.

In another aspect, the steam explosion technology can further pulverize straw whilst destroying zearalenone content in straw, and has greater efficiency in subsequent use of straw as feeds or fermentation materials.

In the present disclosure, the degradation rate of zearalenone is used to evaluate the removal effect of zearalenone, and the theoretical maximum gas yield is used to evaluate the efficiency of steam exploded straw.

According to an example of the present disclosure, the steam pressure of steam explosion is 2.2 MPa, the pressure maintaining time is 144 s, and the water content of straw is 10%. Under the conditions, the maximum degradation rate of zearalenone is achieved.

According to an example of the present disclosure, the steam pressure of steam explosion is 1.48 MPa, the pressure maintaining time is 30 s, and the water content of straw is 50%. Under the conditions, the processed straw has a highest theoretical maximum gas yield.

According to an example of the present disclosure, the steam pressure of steam explosion is 1.88 MPa, the pressure maintaining time is 105.91 s, and the water content of straw is 50%. Under the conditions, the integrated value of the degradation rate of zearalenone and the theoretical maximum gas yield is the optimal combination.

In order to smoothly perform steam explosion, a preferable technical solution is that, before steam explosion, the method further comprises a pre-processing step: drying moldy maize straw at 65° C. for 72 hr or to constant weight, pulverizing to straw particles with a particle size of 2-10 mm, spraying water on the pulverized straw particles based on the water content, and sealing for use.

In order to facilitate verification and adjustment of the steam explosion technology, the present disclosure further comprises, after steam explosion, a step of detecting the degradation rate of zearalenone by HPLC; and further comprises, after steam explosion, a step of detecting the theoretical maximum gas yield of straw by in vitro aerogenesis method.

It should be noted that an example of the present disclosure provides a method for detecting the degradation rate of zearalenone by HPLC and a method for detecting the theoretical maximum gas yield by in vitro aerogenesis method. Based on the actual test and production conditions, those skilled in the art can select other detection methods and detection parameters, which are not repeated any more herein.

The present disclosure has following beneficial effects:

1. The present disclosure provides a method for reducing zearalenone content in straw using steam explosion technology and use thereof, creatively utilizes the huge energy released during steam explosion, and destroys the chemical structure of zearalenone without introducing other harmful chemicals, wherein the steam explosion technology can be used as a completely new technology for reducing zearalenone content in straw.

2. The inventors of the present disclosure further select parameters of the steam explosion technology to give straw containing zearalenone at a lower concentration after processing, and to obtain good implementation parameters and optimum implementation parameters of steam explosion.

### BRIEF DESCRIPTION OF THE DRAWINGS

FIG. 1 is a response surface analysis diagram of a degradation rate of zearalenone in exploded straw at water contents of different levels and under different steam pressure conditions; wherein degradation rate of ZEN (%) represents the degradation rate of zearalenone, water (%) represents the water content, and pressure (mPa) represents the steam pressure (mPa);

FIG. 2 is a response surface analysis diagram of a degradation rate of zearalenone in exploded straw in pressure maintaining time of different levels and under different steam pressure conditions; wherein degradation rate of ZEN (%) represents the degradation rate of zearalenone, time (s) represents the pressure maintaining time, and pressure (mPa) represents the steam pressure (mPa); and

FIG. 3 is a response surface analysis diagram of a theoretical maximum gas yield of exploded straw in pressure maintaining time of different levels and under different steam pressure conditions; wherein A (mL/g) represents the theoretical maximum gas yield, time (s) represents the pressure maintaining time, and pressure (mPa) represents the steam pressure (mPa).

### DETAILED DESCRIPTION OF EMBODIMENTS

The content of the present disclosure is illustrated in more detail hereinafter in conjunction with the following examples. It should be understood that the implementation of the disclosure is not limited to the following examples, and any form of modifications and/or changes of the disclosure will fall within the scope of protection of the disclosure.

In the present disclosure, unless otherwise particularly specified, all parts and percentages are referred to by weight, and all devices and starting materials can be commercially available or are commonly used in the industry. All methods in the following examples, unless otherwise indicated, are conventional methods in the field.

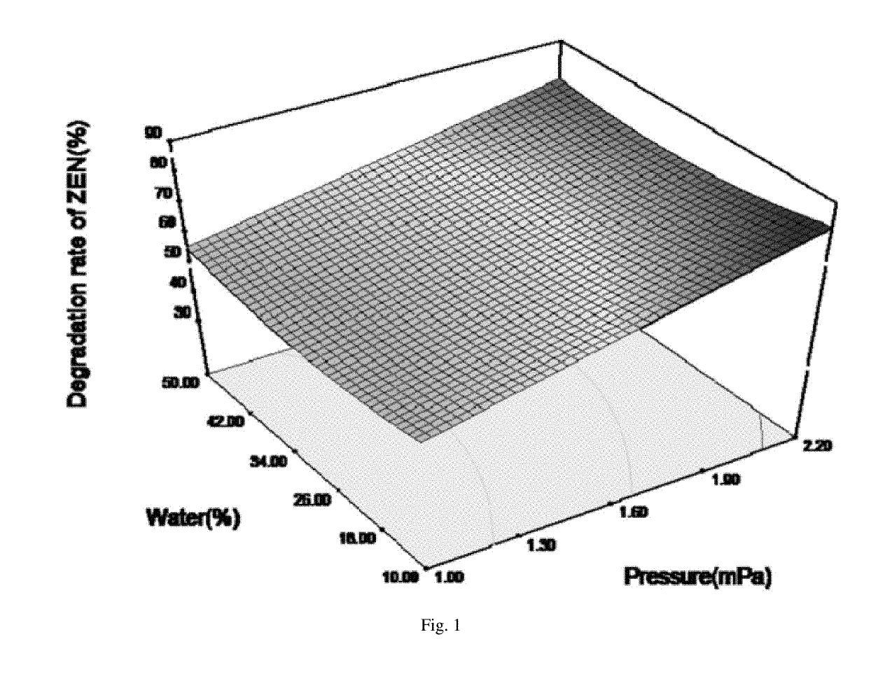

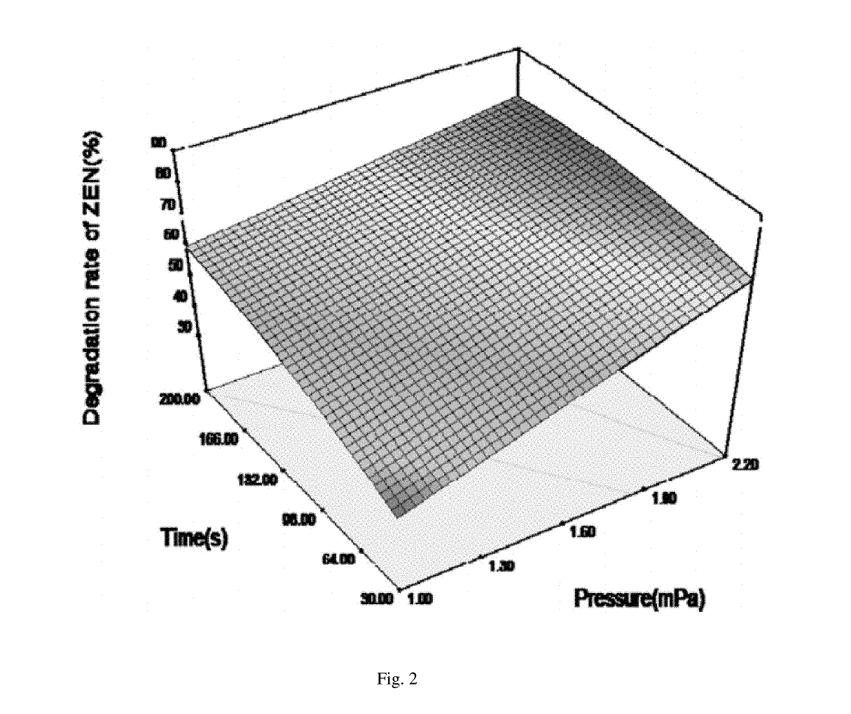

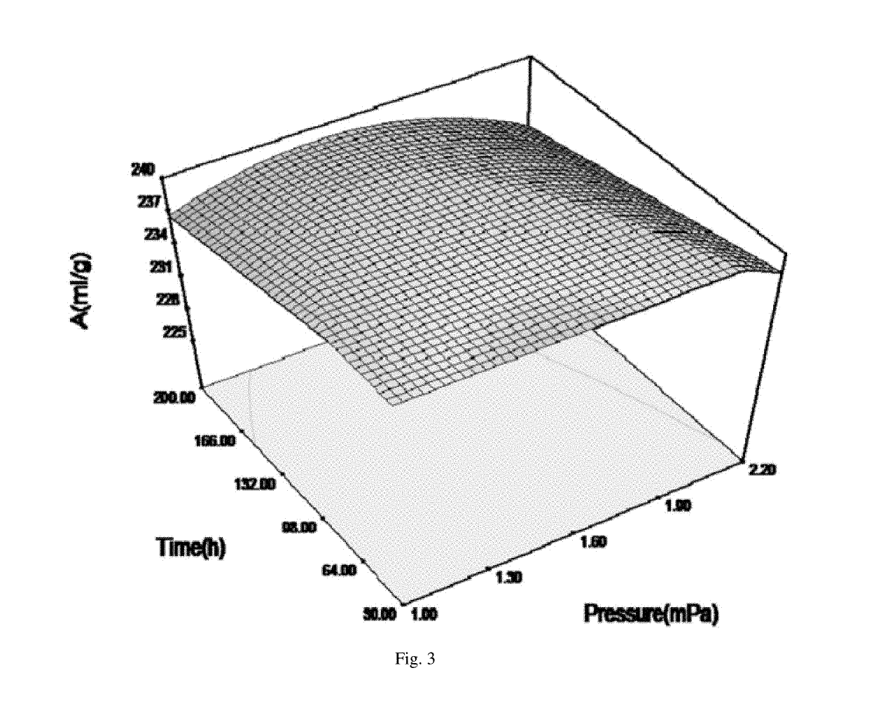

The inventors of the present disclosure give the response surface analysis diagrams of FIG. 1-3 based on a series of test parameters. The disclosure is illustrated in conjunction with the following examples.

### EXAMPLE 1

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 1 MPa, the pressure maintaining time was 200 s, and the water content of straw particles was 10%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr.

According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 67.41%, and the theoretical maximum gas yield was 239.09 mL/g.

### EXAMPLE 2

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 2.2 MPa, the pressure maintaining time was 30 s, and the water content of straw particles was 50%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr. According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 72.18%, and the theoretical maximum gas yield was 240.71 mL/g.

### EXAMPLE 3

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 1.6 MPa, the pressure maintaining time was 115 s, and the water content of straw particles was 30%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr. According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 63.63%, and the theoretical maximum gas yield was 263.61 mL/g.

### EXAMPLE 4

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 2.2 MPa, the pressure maintaining time was 144 s, and the water content of straw was 10%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30 ° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr. According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 83%, and the theoretical maximum gas yield was 224.46 mL/g. Under the conditions, the maximum degradation rate of zearalenone was achieved.

### EXAMPLE 5

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 1.48 MPa, the pressure maintaining time was 30 s, and the water content of straw particles was 50%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30 ° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr. According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 53.18%, and the theoretical maximum gas yield was 245.61 mL/g Under the conditions, the processed straw had the highest theoretical maximum gas yield.

### EXAMPLE 6

A method for reducing zearalenone content in straw using steam explosion technology comprises the following steps:

A: Pre-processing: drying 50 g of moldy maize straw at 65° C. for 72 hr or to constant weight, pulverizing to straw particles with a particle size of 2-10 mm, spraying water on the pulverized straw particles based on the water content, packing and sealing in a plastic bag, and storing at room temperature for about 24 hr;

B: Steam explosion: processing straw particles using a steam explosion method, wherein the steam pressure of steam explosion was 1.88 MPa, the pressure maintaining time was 105.91 s, and the water content of straw was 50%; and

C: Collecting steam exploded straw particles in a conical flask, drying at 65° C. for 72 hr or to constant weight, and storing for later analysis, including detecting the degradation rate of zearalenone by HPLC and detecting the theoretical maximum gas yield of straw by in vitro aerogenesis method.

The method for detecting the degradation rate of zearalenone by HPLC was: 1 g of processed straw was transferred into a 50 mL centrifuge tube, followed by addition of 8 mL of acetonitrile-water-formic acid (v/v, 84:16:0.1) solution, fully mixing on a shaker for 10 min, ultrasonic oscillation for 30 min, centrifugation at 10,000 rpm for 5 min, and collecting the filtrate. 8 mL of the filtrate was filtered through Mycosep226 multifunctional purification column to give a purified liquid. 200 μL of the purified liquid was pipetted to a brown glass bottle with a stopper, and tested on a machine. The quantitative detection conditions were: the mobile phase was acetonitrile-water (v/v, 25:75) solution, the flow rate was set as 0.5 mL/min, the column temperature was 30° C., the sample injection was 25 μL; and the detection parameters of the fluorescence detector were set at excitation wavelength of 360 nm and emission wavelength of 440 nm. Finally, the concentration of zearalenone in unexploded moldy straw and that in exploded straw extract (purified liquid) were obtained respectively, ng/mL. The concentration was multiplied by the volume (8 mL) of the extract, to give the zearalenone content in 1 g of sample, ng. The result obtained by subtracting the zearalenone content in exploded straw from the zearalenone content in unexploded moldy straw was divided by the zearalenone content in unexploded moldy straw, and the degradation rate of zearalenone in exploded moldy straw was finally obtained.

The method for detecting the theoretical maximum gas yield of straw by in vitro aerogenesis method was as follows: 0.3 g of steam exploded straw was added into 100 mL of a fermentator, and anaerobically incubated at constant temperature together with 45 mL of anaerobic fermentation broth (volume ratio of rumen liquid to buffer solution was 1:2) at 39° C. for 72 hr, and the pressure in the fermentator was determined using a pressure gauge in 0, 2, 4, 8, 12, 18, 24, 36, 48 and 72 hr. According to the formula GPt=Pt×V/(100.3×w) (GPt is the cumulative gas yield at timepoint t, Pt is the pressure in each fermentator at time point t, V is the volume of residual fermentation broth in the fermentator, 100.3 is the atmospheric pressure, and w is the straw mass in each fermentator), the cumulative gas yield in the each fermentator at different timepoints was obtained, mL/g. By referring to the exponential function model GPt=[1-e-c×(t−lag)]×A (GPt is the cumulative gas yield at timepoint t, c is the gas generation rate, t is the gas generation time, lag is the gas generation lag time, and A is the theoretical maximum gas yield of the fermentation substrate at the gas generation rate) proposed by rskov et al., the theoretical maximum gas yield of the fermentation substrate at the gas generation rate was finally obtained through nonlinear fitting of the cumulative gas yield data, mL/g.

In this example, the degradation rate of zearalenone in steam exploded straw was 71.31%, and the theoretical maximum gas yield was 242.11 mL/g. Under the conditions, the maximum degradation rate of zearalenone was achieved.

Finally, it should be noted that the above examples are only used to illustrate, rather than to limit, the technical solution of the present disclosure. While the disclosure is illustrated in detail with reference to preferred examples, it should be understood that the foregoing description is only embodiments of the disclosure, and is not used to limit the scope of protection of the disclosure. Any modification, equivalent replacement, improvement, or the like made within the spirit and principle of the disclosure should be included within the scope of protection of the disclosure.

What is claimed is:

1. Use of steam explosion technology for reducing zearalenone content in straw.

2. A method for reducing zearalenone content in straw using steam explosion technology, wherein straw is processed using a steam explosion method with 1-2.2 MPa of steam pressure of steam explosion, 30-200 s of pressure maintaining time, and 10-50% water content of straw.

3. The method according to claim 2, wherein the steam pressure of steam explosion is 2.2 MPa, the pressure maintaining time is 144 s, and the water content of straw is 10%.

4. The method according to claim 2, wherein the steam pressure of steam explosion is 1.48 MPa, the pressure maintaining time is 30 s, and the water content of straw is 50%.

5. The method according to claim 2, wherein the steam pressure of steam explosion is 1.88 MPa, the pressure maintaining time is 105.91 s, and the water content of straw is 50%.

6. The method according to claim 2, further comprising, before steam explosion, a pre-processing step: drying moldy maize straw at 65° C. for 72 hr or to constant weight, pulverizing to straw particles with a particle size of 2-10 mm, spraying water on the pulverized straw particles based on the water content, and sealing for use.

7. The method according to claim 2, further comprising, after steam explosion, a step of detecting a degradation rate of zearalenone by HPLC.

8. The method according to claim 2, further comprising, after steam explosion, a step of detecting a theoretical maximum gas yield of straw by in vitro aerogenesis method.
